(19) United States
(12) Patent Application Publication
(10) Pub. No.: US 2016/0276685 A1
(43) Pub. Date: Sep. 22, 2016

(54) BATTERY, METHOD OF SWITCHING HYDROGEN STORAGE CONTAINER, AND RECORDING MEDIUM

(71) Applicant: BROTHER KOGYO KABUSHIKI KAISHA, Nagoya-shi (JP)

(72) Inventor: Kentaro Murayama, Nagoya-shi (JP)

(21) Appl. No.: 15/045,882

(22) Filed: Feb. 17, 2016

(30) Foreign Application Priority Data
Mar. 17, 2015 (JP) 2015-053883

(51) Int. Cl. H01M 8/04746; H01M 8/04082; H01M 8/04492; H01M 8/04089; H01M 8/0432

(52) U.S. Cl. CPC H01M 8/04753; H01M 8/04089; H01M 8/0432; H01M 8/04492; H01M 8/04201

(57) ABSTRACT

Provided are a battery in which the occurrence of condensation is suppressed, a method of switching a hydrogen storage container in a battery, and a computer readable recording medium recording a computer program causing a computer to switch a hydrogen storage container. A fuel cell includes cylinder units each of which stores hydrogen and supplies hydrogen from an inflow/outflow port having an on-off valve, a stack which is supplied with hydrogen from a cylinder unit and generates power, and a control unit which controls switching of the cylinder unit which supplies hydrogen. The control unit switches the cylinder unit which supplies hydrogen according to a power generation amount of the stack or a cumulative value of the power generation amount.

### CROSS-REFERENCE TO RELATED APPLICATIONS

This Nonprovisional application claims priority under 35 U.S.C. §119(a) on Patent Application No. 2015-053883 filed in Japan on Mar. 17, 2015, the entire contents of which are hereby incorporated by reference.

### BACKGROUND

1. Technical Field

The present invention relates to a battery including a plurality of hydrogen storage containers each of which supplies hydrogen from an inflow/outflow port having an on-off valve, a power generating unit which is supplied with hydrogen from the hydrogen storage container and generates power, and a control unit which controls switching of the hydrogen storage container which supplies hydrogen, a method of switching a hydrogen storage container in a battery, and a computer readable recording medium which records a computer program causing a computer to switch a hydrogen storage container.

2. Description of Related Art

As a battery that feeds hydrogen to a negative pole and obtains electromotive force, there are a fuel cell, a nickel-hydrogen battery, and the like.

The fuel cell is high in power generation efficiency and not affected by the size of a load and can construct a co-generation system, and thus the fuel cell has been reviewed to be used for various uses e.g. digital home appliances such as personal computers and mobile phones, electric cars, trains, base stations of mobile phones, and power plants.

In the fuel cell, hydrogen is supplied from a hydrogen storing alloy filled in a hydrogen storage cylinder (hydrogen storage tank) to a power generating unit, fuel gas including hydrogen comes into contact with a negative pole of the power generating unit, and oxidation gas including oxygen such as air comes into contact with a positive pole, and thus an electrochemical reaction occurs on both electrodes, and electromotive force is accordingly generated.

In order to operate the fuel cell for a long time, a plurality of hydrogen storage cylinders are commonly installed.

Japanese Patent Laid-open Publication No. 2001-295996 discloses an invention of a fuel cell in which an on-off valve is installed on each of inflow/outflow ports of a plurality of hydrogen storage tanks, and a pressure sensor is attached to a hydrogen supply pipe connected to the inflow/outflow port via a communication pipe, and when the pressure is equal to or less than a threshold value, the hydrogen storage tank to be used is sequentially switched. In the invention disclosed in Japanese Patent Laid-open Publication No. 2001-295996, hydrogen is continuously supplied by a simple configuration.

However, since hydrogen emission of the hydrogen storing alloy is an endothermic reaction, if one hydrogen storage tank is intensively used as in the fuel cell disclosed in Japanese Patent Laid-open Publication No. 2001-295996, when a load is high and a hydrogen emission amount is increased, the temperature of the hydrogen storage tank is decreased, and thus condensation is likely to occur on the surface. When water droplets are attached due to the condensation, components rust and degrade, and a problem such as a short circuit of an electric wiring is likely to occur.

### SUMMARY

The present invention was made in light of the foregoing, and it is an object of the present invention to provide a battery, a method of switching a hydrogen storage container in a battery, and a computer readable recording medium recording a computer program causing a computer to switch a hydrogen storage container, which are capable of suppressing the occurrence of condensation and preventing a problem such as a short circuit of an electric wiring caused by rust or degradation of a component.

A battery according to an aspect of the present invention comprises: a plurality of hydrogen storage containers each of which stores hydrogen and supplies hydrogen from an inflow/outflow port including an on-off valve; a power generating unit which is supplied with hydrogen from the hydrogen storage container and generates power; and a control unit which controls switching the on-off valve of the hydrogen storage container which supplies hydrogen, wherein the control unit is configured to switch the on-off valve of the hydrogen storage container which supplies hydrogen according to a power generation amount of the power generating unit or a cumulative value of the power generation amount.

A battery according to an aspect of the present invention comprises: a plurality of hydrogen storage containers each of which stores hydrogen and supplies hydrogen from an inflow/outflow port including an on-off valve; a power generating unit which is supplied with hydrogen from the hydrogen storage container and generates power; and a control unit which controls switching the on-off valve of the hydrogen storage container which supplies hydrogen, wherein the control unit is configured to switch the on-off valve of the hydrogen storage container which supplies hydrogen based on an ambient temperature of the hydrogen storage container or ambient humidity of the hydrogen storage container.

A method of switching a hydrogen storage container in a battery including a plurality of hydrogen storage containers each of which stores hydrogen and supplies hydrogen to a power generating unit, according to an aspect of the present invention, comprises: determining whether or not an ambient temperature of the hydrogen storage container is equal to or higher than a predetermined value or ambient humidity of the hydrogen storage container is equal to or lower than a predetermined value; performing transition to a first mode in which hydrogen is supplied to the power generating unit simultaneously through a plurality of hydrogen storage containers when the ambient temperature of the hydrogen storage container is determined not to be equal to or higher than the predetermined value and the ambient humidity of the hydrogen storage container is determined not to be equal to or lower than the predetermined value; performing transition to a second mode in which the hydrogen storage container is used one by one or a third mode in which the hydrogen storage container is used on average when the ambient temperature of the hydrogen storage container is determined to be equal to or higher than the predetermined value or the ambient humidity of the hydrogen storage container is determined to be equal to or lower than the predetermined value; determining whether or not a condition in which condensation occurs on the hydrogen storage container is satisfied; and switching the hydrogen storage container which supplies hydrogen when the condition in which condensation occurs is determined to be satisfied.

A computer readable recording medium according to an aspect of the present invention, recording a computer program causing a computer which controls switching a hydrogen storage container in a battery including a plurality of hydrogen storage containers each of which stores hydrogen and supplies hydrogen to a power generating unit to execute a process of: determining whether or not an ambient temperature of the hydrogen storage container is equal to or higher than a predetermined value or ambient humidity of the hydrogen storage container is equal to or lower than a predetermined value; performing transition to a first mode in which hydrogen is supplied to the power generating unit simultaneously through a plurality of hydrogen storage containers when the ambient temperature of the hydrogen storage container is determined not to be equal to or higher than the predetermined value and the ambient humidity of the hydrogen storage container is determined not to be equal to or lower than the predetermined value; performing transition to a second mode in which the hydrogen storage container is used one by one or a third mode in which the hydrogen storage container is used on average when the ambient temperature of the hydrogen storage container is determined to be equal to or higher than the predetermined value or the ambient humidity of the hydrogen storage container is determined to be equal to or lower than the predetermined value; determining whether or not a condition in which condensation occurs on the hydrogen storage container is satisfied; and outputting a command for switching the hydrogen storage container which supplies hydrogen when the condition in which condensation occurs is determined to be satisfied.

According to the present invention, since the battery is configured to switch the hydrogen storage container when a possibility that condensation on the surface of the hydrogen storage container will occur is high, it is possible to suppress the occurrence of condensation satisfactorily. Accordingly the occurrence of a problem such as a short circuit of an electric wiring caused by rust or degradation of a component is suppressed.

The above and further objects and features will more fully be apparent from the following detailed description with accompanying drawings.

### BRIEF DESCRIPTION OF THE SEVERAL VIEWS OF THE DRAWINGS

FIG. 1 is a block diagram illustrating a fuel cell according to an embodiment of the present invention;

FIG. 2 is a block diagram illustrating a stack, a radiator, a louver, and a hydrogen storage unit;

FIG. 3 is a flowchart illustrating a hydrogen supply process performed by a CPU 91;

FIG. 4 is a flowchart illustrating a subroutine process according to a mode A;

FIG. 5 is a flowchart illustrating a subroutine process related to decision of the number of on-off valves of cylinder units to be opened;

FIG. 6 is a flowchart illustrating a subroutine process related to condensation occurrence condition checking;

FIG. 7 is a flowchart illustrating a subroutine process according to a mode B;

FIG. 8 is a flowchart illustrating a subroutine process according to a mode C; and

FIG. 9 is a flowchart illustrating a residual hydrogen amount adjustment process between cylinder units by a CPU 91.

### DETAILED DESCRIPTION

Hereinafter, the present invention will be described in detail based on the appended drawings illustrating an exemplary embodiment thereof.

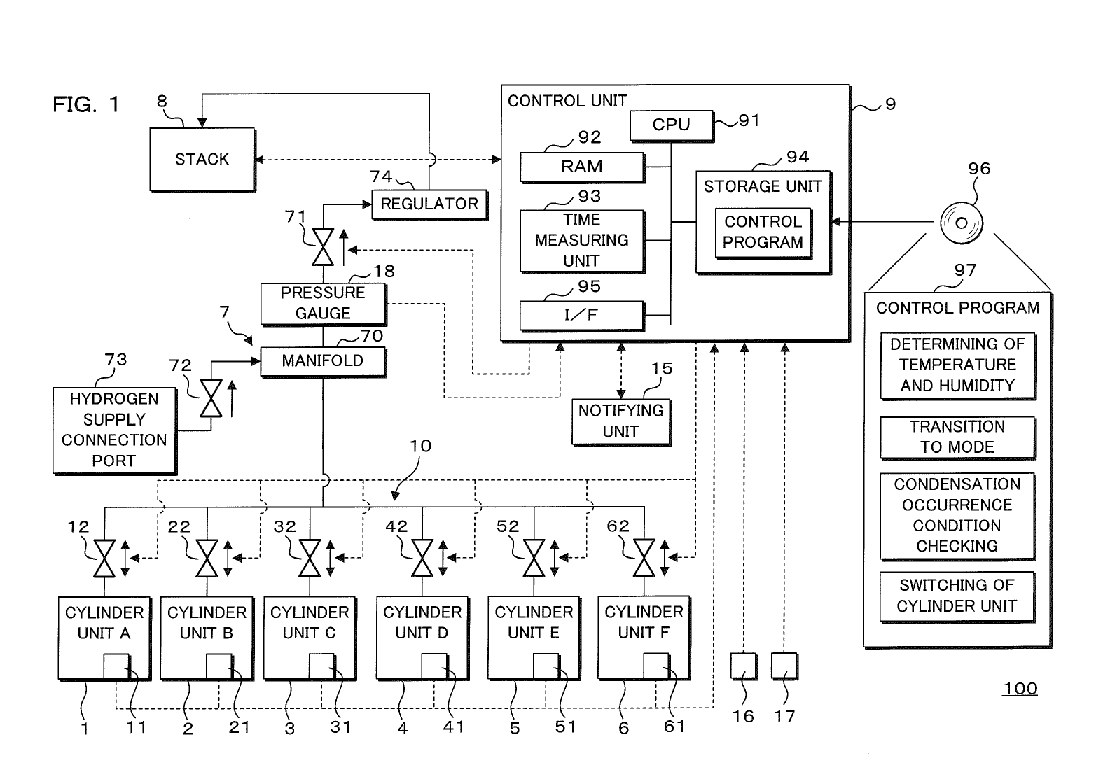

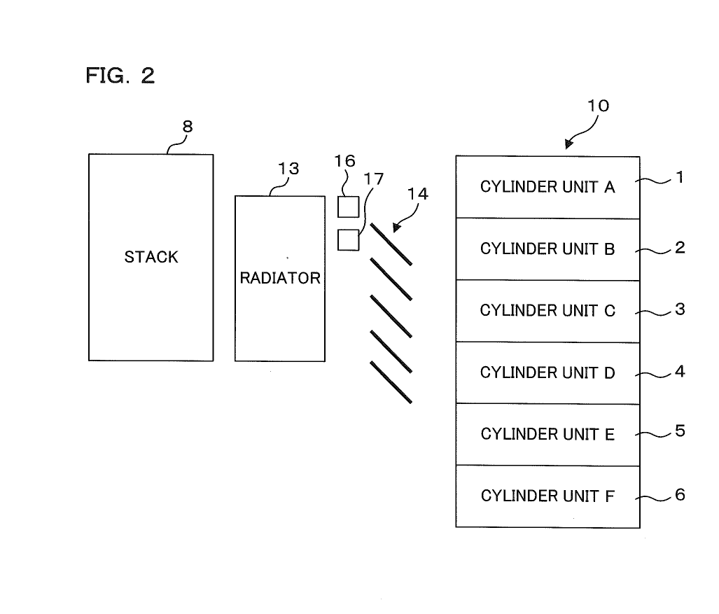

FIG. 1 is a block diagram illustrating a fuel cell 100 according to an embodiment of the present invention, and FIG. 2 is a block diagram illustrating a stack, a radiator, a louver, and a hydrogen storage unit.

For example, the fuel cell 100 is a fuel cell such as a polymer electrolyte fuel cell.

The fuel cell 100 includes a hydrogen supply unit 7, a stack 8, a control unit 9, a hydrogen storage unit 10, a notifying unit 15, a temperature sensor 16, a humidity sensor 17, and a pressure gauge 18.

The hydrogen storage unit 10 includes a cylinder unit “A” 1, a cylinder unit “B” 2, a cylinder unit “C” 3, a cylinder unit “D” 4, a cylinder unit “E” 5, a cylinder unit “F” 6, temperature sensors 11, 21, 31, 41, 51, and 61 that detect ambient temperature of the respective cylinder units, and on-off valves 12, 22, 32, 42, 52, and 62 through which hydrogen flows into or flows out of the respective cylinder units. Preferably, the temperature sensors 11, 21, 31, 41, 51, and 61 are capable of detecting the surface temperature of the cylinder units. Each of the cylinder units includes four cylinders, and one on-off valve is installed for the four cylinders.

The hydrogen supply unit 7 includes a manifold 70, a hydrogen supply connection port 73, and a regulator 74. The cylinder units are connected to the manifold 70 via the on-off valves 12, 22, 32, 42, 52, and 62. The hydrogen supply connection port 73 is connected to the manifold 70 via an on-off valve 72 so that hydrogen is fed to the cylinder units through the manifold 70 and then stored in the cylinder units.

The regulator 74 is connected to the manifold 70 via the pressure gauge 18 and an on-off valve 71 so that hydrogen is fed from the hydrogen storage unit 10 to the regulator 74.

The regulator 74 is connected to the stack 8.

The stack 8 is obtained by stacking and packaging a plurality of cells each of which is obtained by sticking a negative pole, a solid polymer film and a positive pole to one another, integrating them and putting them between conductive plates.

Fuel gas including hydrogen flowed in from the hydrogen storage unit 10 comes into contact with the negative pole, and oxidation gas including oxygen such as air comes into contact with the positive pole, and thus an electrochemical reaction occurs on both electrodes, and electromotive force is accordingly generated. In the electrochemical reaction, water is produced due to a reaction between hydrogen ions having passed through the electrolyte membrane from the negative pole side and oxygen included in the oxidation gas.

The control unit 9 includes a central processing unit (CPU) that controls operations of respective components of the control unit 9, and the CPU 91 is connected to a RAM 92, a time measuring unit 93, a storage unit 94, and an I/F 95 via a bus.

The storage unit 94 is a non-volatile memory such as an electrically erasable programmable ROM (EEPROM), and stores a control program 97 for performing hydrogen supply control (cylinder unit switching control) according to the present embodiment.

The control program 97 is recorded in a recording medium 96 such as a compact disc (CD)-ROM, a digital versatile disc (DVD)-ROM, Blu-ray® disc (BD), a hard disk drive, or a solid state drive, which is a portable computer readable medium and the CPU 91 may read the control program 97 from the recording medium 96 and store the control program 97 in the storage unit 94.

Further, the control program 97 according to the present invention may be acquired from an external computer (not illustrated) connected to a communication network and stored in the storage unit 94.

The RAM 92 is a memory such as a dynamic RAM (DRAM) or a static RAM (SRAM), and temporarily stores the control program 97 read from the storage unit 94 and various kinds of data generated by an operation process of the CPU 91 when the process is executed.

The time measuring unit 93 measures a time for predetermined determination which will be described later.

The notifying unit 15 is installed on an operation panel (not illustrated) or the like, and outputs notification information through a text or the like. The notification may be given by lighting of an LED lamp, a sound output, or the like.

The pressure gauge 18 detects the pressure of hydrogen supplied from the entire hydrogen storage unit 10.

The control unit 9 is connected to the stack 8, the on-off valves, the notifying unit 15, the temperature sensors including the temperature sensor 16, the humidity sensor 17, and the pressure gauge 18 via the I/F 95.

As illustrated in FIG. 2, a radiator 13 and a louver 14 are arranged between the stack 8 and the hydrogen storage unit 10.

An electrochemical reaction occurring in the stack 8 is an exothermic reaction, and the stack 8 is cooled down by the radiator 13. The cylinder of the hydrogen storage unit 10 is a hydrogen storing alloy tank, and a reaction by which the hydrogen storing alloy emits hydrogen is an endothermic reaction. Thus, heated air is fed from the radiator 13 to the hydrogen storage unit 10. A heated air amount and a heated air destination (a cylinder unit to which heated air is fed) are adjusted by adjusting an angle of a louver board of the louver 14.

In the hydrogen storage unit 10, the cylinder units from “F” 6 to “A” 1 are sequentially stacked. The radiator 13 is arranged at a height position nearby an upper portion of the hydrogen storage unit 10 with respect to the hydrogen storage unit 10.

The temperature sensor 16 and the humidity sensor 17 are arranged between the radiator 13 and the louver 14.

The fuel cell 100 of the present embodiment has three hydrogen supply modes, that is, a mode A, a mode B, and a mode C as the hydrogen supply mode.

(1) Mode A

A priority of a cylinder unit to be used (in which the on-off valve is opened) is changed.

Since a cylinder unit is used on average, a period of time for refilling with hydrogen is reduced. For example, if it is assumed that a next cylinder unit is used after one cylinder unit is used up, and it takes 10 hours to refill one cylinder unit with hydrogen 100%, it takes 5 hours to refill with hydrogen when hydrogen of each cylinder unit is used by 50%.

(2) Mode B

A priority of a cylinder unit to be used is fixed.

After one cylinder unit is used up, a next cylinder unit is used.

As described above, a hydrogen refilling period of time is long, but when replacing a cylinder unit, the cylinder unit to be replaced is only the cylinder unit which has already been expended.

(3) Mode C

In order to stably supply hydrogen necessary for an operation, a plurality of held cylinder units are simultaneously used from the beginning. A decrease in temperature of a cylinder unit is suppressed one by one.

A method of switching a cylinder unit according to an embodiment of the present invention will be described below.

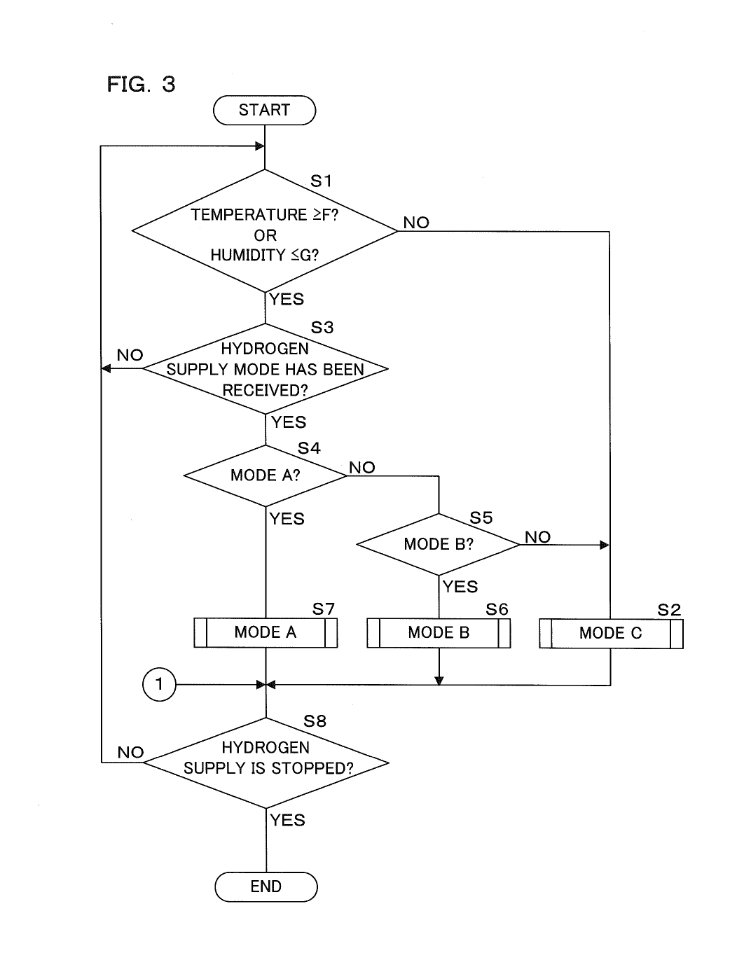

FIG. 3 is a flowchart illustrating a hydrogen supply process performed by the CPU 91.

First, the CPU 91 determines whether or not the temperature acquired from the temperature sensor 16 is equal to or higher than F° C. or whether or not the humidity acquired from the humidity sensor 17 is equal to or lower than G % (S1). The temperature F° C. and the humidity G % at which condensation is considered to occur when transition to the mode C is not performed, based on previously obtained experimental data, a use state, and a use condition are stored in the storage unit 94.

When it is determined that the temperature is not equal to or higher than F° C. and the humidity is not equal to or lower than G % (NO in S1), the CPU 91 performs transition to the mode C as a compulsory setting (S2).

When it is determined that the temperature is equal to or higher than F° C. or the humidity is equal to or lower than G % (YES in S1), the CPU 91 determines whether or not the hydrogen supply mode to be used has been received from the user (S3). The user gives an instruction by pushing a button of the hydrogen supply mode (use mode) to be used down or inputting the hydrogen supply mode to be used using the operation panel.

Further, the hydrogen supply mode may be selected by the CPU 91. Alternatively, one hydrogen supply mode that is decided in advance may be selected as an initial setting.

When the use mode is determined not to have been received (NO in S3), the CPU 91 causes the process to return to step S1.

When the use mode is determined to have been received (YES in S3), the CPU 91 determines whether or not the mode A has been selected (S4). When the mode A is determined not to have been selected (NO in S4), the CPU 91 determines whether or not the mode B has been selected (S5). When the mode B is determined not to have been selected (NO in S5), the CPU 91 causes the process to proceed to step S2. In other words, the CPU 91 performs transition to the mode C.

When the mode B is determined to have been selected (YES in S5), the CPU 91 performs transition to the mode B (S6).

When the mode A is determined to have been selected (YES in S4), the CPU 91 performs transition to the mode A (S7).

The CPU 91 determines whether or not the hydrogen supply is stopped (S8). This determination is performed according to whether or not a hydrogen supply stop instruction has been given from the user or whether or not a predetermined hydrogen supply stop condition is satisfied by the CPU 91.

When determining that the hydrogen supply is not stopped (NO in S8), the CPU 91 causes the process to return to step S1. When determining that the hydrogen supply is stopped (YES in S8), the CPU 91 ends the hydrogen supply process.

A subroutine process according to the mode A will be described below.

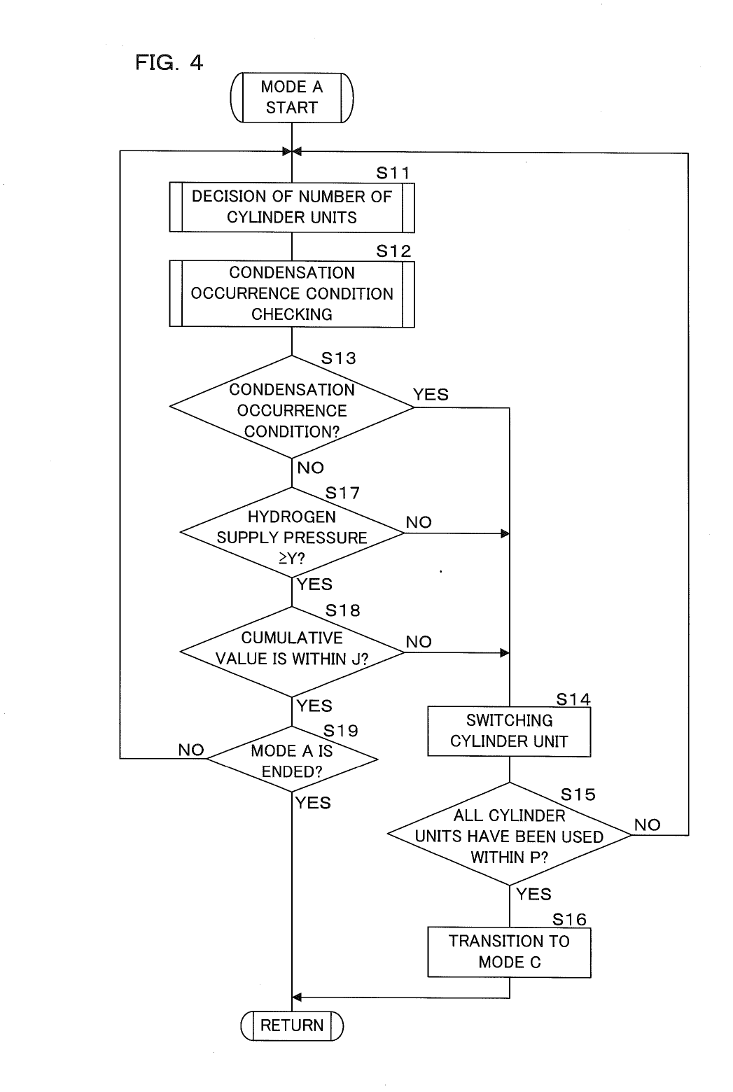

FIG. 4 is a flowchart illustrating the subroutine process according to the mode A.

First, the CPU 91 decides the number of cylinder units in which the on-off valves are to be opened (S11).

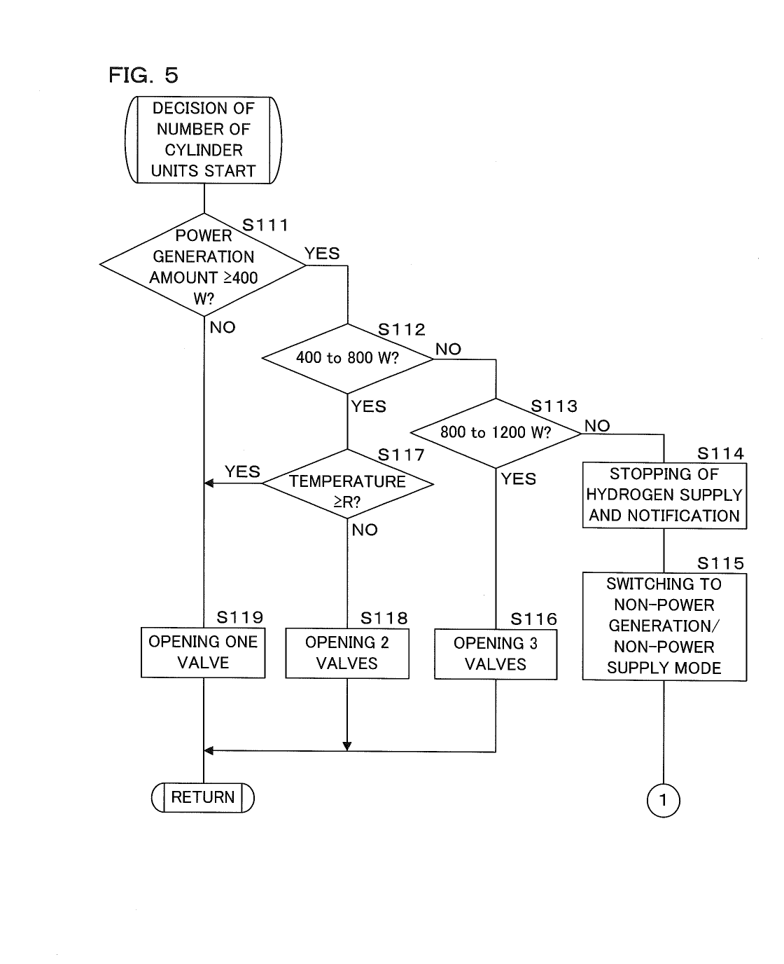

FIG. 5 is a flowchart illustrating a subroutine process related to decision of the number of cylinder units in which the on-off valves are to be opened. A relation between a power generation amount and the number of used cylinder units on which no condensation occurs is obtained by an experiment in advance and stored in the storage unit 94. The following value of the power generation amount is an example.

First, the CPU 91 determines whether or not a current power generation amount is equal to or more than 400 W (a first threshold value) (S111).

When the power generation amount is determined to be equal to or more than 400 W (YES in S111), the CPU 91 determines whether or not the power generation amount is 400 to 800 W (a second threshold value) (S112).

When the power generation amount is determined not to be 400 to 800 W (NO in S112), the CPU 91 determines whether or not the power generation amount is 800 to 1200 W (S113).

When the power generation amount is determined not to be 800 to 1200 W (NO in S113), the CPU 91 stops the hydrogen supply, and a notification indicating that the hydrogen supply is stopped is given through the notifying unit 15 (S114). Then, the CPU 91 switches the stack 8 side to a non-power generation/non-power supply mode (S115), and causes the process to proceed to step S8 related to the flowchart of the hydrogen supply process of FIG. 3.

When the power generation amount is determined not to be equal to or more than 400 W in step S111 of FIG. 5 (NO in S111), the CPU 91 sets 1 as the number of on-off valves of cylinder units to be opened. Then, the CPU 91 opens the on-off valve of the cylinder unit having the highest priority in the following Table 1 (S119). Since the radiator 13 and the louver 14 are installed nearby the upper side as described above, and the cylinder unit at the lower side of the hydrogen storage unit 10 is less heated, the occurrence of condensation is suppressed by setting a high priority to the cylinder unit at the lower side and preferentially using the cylinder unit at the lower side. In the initial state, the cylinder unit F is selected.

TABLE 1

| | | NUMBER OF SWITCHING | | | | | |
|---|---|---|---|---|---|---|---|
| PRIORITY | INITIAL STATE | 1 | 2 | 3 | 4 | 5 | 6 |
| UNIT A | 3 | 4 | 5 | 6 | 1 | 2 | 3 |
| UNIT B | 5 | 6 | 1 | 2 | 3 | 4 | 5 |
| UNIT C | 6 | 1 | 2 | 3 | 4 | 5 | 6 |
| UNIT D | 4 | 5 | 6 | 1 | 2 | 3 | 4 |
| UNIT E | 2 | 3 | 4 | 5 | 6 | 1 | 2 |
| UNIT F | 1 | 2 | 3 | 4 | 5 | 6 | 1 |

When the power generation amount is determined to be 400 to 800 W (YES in S112), the CPU 91 determines whether or not the temperature acquired from the temperature sensor 16 is equal to or higher than R° C. (S117). A temperature R° C. at which hydrogen necessary for power generation of 800 W can be emitted through one cylinder unit is obtained by an experiment in advance and stored in the storage unit 94.

When the temperature is determined to be equal to or higher than R° C. (YES in S117), the CPU 91 causes the process to proceed to step S119. The number of the on-off valve to be opened is one, but no condensation occurs.

When the ambient temperature is determined not to be equal to or higher than R° C. (NO in S117), the CPU 91 sets 2 as the number of on-off valves of cylinder units to be opened (S118). When the number of on-off valves to be opened is 2, the on-off valves of the two cylinder units having the high priority in Table 1 are opened.

When the power generation amount is determined to be 800 to 1200 W (YES in S113), the CPU 91 sets 3 as the number of on-off valves of cylinder units to be opened (S116). When the number of on-off valves of cylinder units to be opened is 3, the on-off valves of the three cylinder units having the high priority in Table 1 are opened.

Then, the subroutine process related to the decision of the number of cylinder units in which the on-off valves are to be opened ends.

After the on-off valve is opened, the CPU 91 checks whether or not the cylinder unit in which the on-off valve is being opened satisfies a condensation occurrence condition (S12). In other words, when the on-off valve of one cylinder unit is opened, a condensation occurrence condition checking process is performed on the cylinder unit, and when the on-off valves of two or more cylinder units are opened, the condensation occurrence condition checking process is performed on each of the cylinder units.

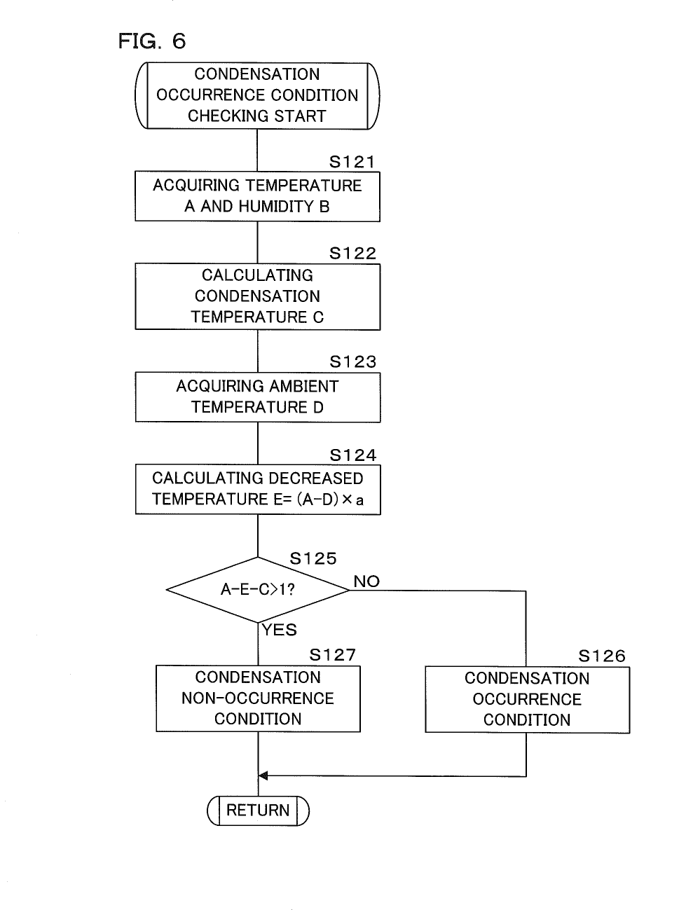

FIG. 6 is a flowchart illustrating a subroutine process related to condensation occurrence condition checking.

The CPU 91 acquires temperature A° C. and humidity B % of heated air fed to the cylinder unit. In other words, the CPU 91 acquires the temperature A° C. and the humidity B % from the temperature sensor 16 and the humidity sensor 17, respectively (S121).

The CPU 91 calculates a condensation temperature C° C. based on the temperature A° C. and the humidity B % using a saturated vapor pressure curve (S122). For example, when the temperature A is 28° C., and the humidity B is 80%, it is understood from the saturated vapor pressure curve that a dew-point temperature is about 24° C., and thus C is 24° C.

The CPU 91 acquires an ambient temperature D° C. of the cylinder unit from the temperature sensor of the cylinder unit being in use (S123).

The CPU 91 calculates a decrease in temperature (decreased temperature E) of air being sent when the surface of the cylinder unit is heated (S124). The decreased temperature E (° C.) is obtained by the following Formula (1).

E=(A−D)×a (1)

Since “a” changes according to a shape of a cylinder, a flow velocity of sent air, a period of time in which sent air comes into contact with a cylinder, or the like, “a” is checked and decided by an experiment in advance and stored in the storage unit 94. “a” is a number larger than at least 0. For example, “a” is 0.1. When the temperature A is lower than the temperature D, the cylinder unit is not heated, and thus air may not be sent.

The CPU 91 determines whether or not A−E−C>1 is satisfied (S125).

When A−E−C is equal to or smaller than 0, condensation occurs. Here, A−E−C>1 is set in order to take a margin. When it is simply determined whether or not condensation occurs, it is desirable to replace 1 with 0.

When A−E−C>1 is determined not to be satisfied (NO in S125), the CPU 91 determines that the condensation occurrence condition is satisfied (S126), and when A−E−C>1 is determined to be satisfied (YES in S125), it is determined that the condensation non-occurrence condition is satisfied (S127), and the subroutine process ends.

In the subroutine process of the mode A, the CPU 91 determines whether or not it is determined that the condensation occurrence condition is satisfied by the subroutine process related to the condensation occurrence condition checking (S13).

When the condensation occurrence condition is determined to be satisfied (YES in S13), the CPU 91 switches the cylinder unit (S14).

When the unit F in the initial state is assumed to be currently used, the CPU 91 performs switching to the cylinder unit in which the priority in a first column in Table 1 is high and the temperature is equal to or higher than a predetermined value. In other words, when the temperature of the unit C is equal to or higher than a predetermined value, switching from the cylinder unit F in the initial state to the cylinder unit C is performed.

The CPU 91 determines whether or not all cylinder units of the hydrogen storage unit 10 have been used when a period of time, which is measured by the time measuring unit 93 after opening the on-off valve of the cylinder unit in step S11, is within P (S15).

When all cylinder units are determined not to have been used within the period P of time (NO in S15), the CPU 91 causes the process to return to step S11.

When the cylinder units are determined to have been used within the period P of time (YES in S15), the CPU 91 performs transition to the mode C (S16), and the subroutine process of the mode A ends. When all the cylinder units are in a state close to a condition in which condensation occurs, and when the mode A is continued, it may be difficult to prevent condensation, and thus it is necessary to perform transition to mode C in which all the cylinder units are fully open and processed.

When the condensation occurrence condition is determined not to be satisfied in step S13 (NO in S13), the CPU 91 determines whether or not hydrogen supply pressure acquired from the pressure gauge 18 is equal to or higher than Y (kPa) (S17). Here, Y is a lower limit value (limit value) of the pressure of hydrogen necessary for supplying to the stack 8 or a value obtained by adding a predetermined value to the lower limit value.

When the hydrogen supply pressure is determined not to be equal to or higher than Y (kPa) (NO in S17), the CPU 91 causes the process to step S14.

When the hydrogen supply pressure is determined to be equal to or higher than Y (kPa) (YES in S17), the CPU 91 determines whether or not a cumulative value of the power generation amount after switching to the cylinder unit at a current point in time is within J (W) (S18). The cumulative value J (W) is decided based on the ambient temperature of the cylinder unit by which hydrogen is currently being supplied and a hydrogen use amount per hour. When the ambient temperature of the cylinder unit is low, and the hydrogen use amount per hour is large, a possibility that condensation will occur is high, but switching is promoted by lowering the threshold value J (W) for determining switching of the cylinder unit, and thus the occurrence of condensation can be suppressed. Then, when the ambient temperature of the cylinder unit is high, and the hydrogen use amount per hour is small, the same cylinder unit can be continuously used by increasing the threshold value J (W).

When the cumulative value of the power generation amount is determined not to be within J (W) (NO in S18), that is, when the cumulative value is determined to exceed J, the CPU 91 causes the process to proceed to step S14. As described above, when the cumulative value of the power generation amount has exceeded J (W), the cylinder unit is switched, and thus the cylinder unit can equally be expended.

When the cumulative value of the power generation amount is determined to be within J (W) (YES in S18), the CPU 91 determines whether or not the mode A is ended (S19). The determination as to whether or not the mode A is ended is performed according to whether or not an instruction to end the mode A has been received from the user or whether or not a predetermined condition for ending the mode A is determined to have been satisfied by the CPU 91.

When determining that the mode A is not ended (NO in S19), the CPU 91 causes the process to return to step S11. When determining that the mode A is ended (YES in S19), the CPU 91 ends the subroutine process.

The subroutine process according to the mode B will be described below.

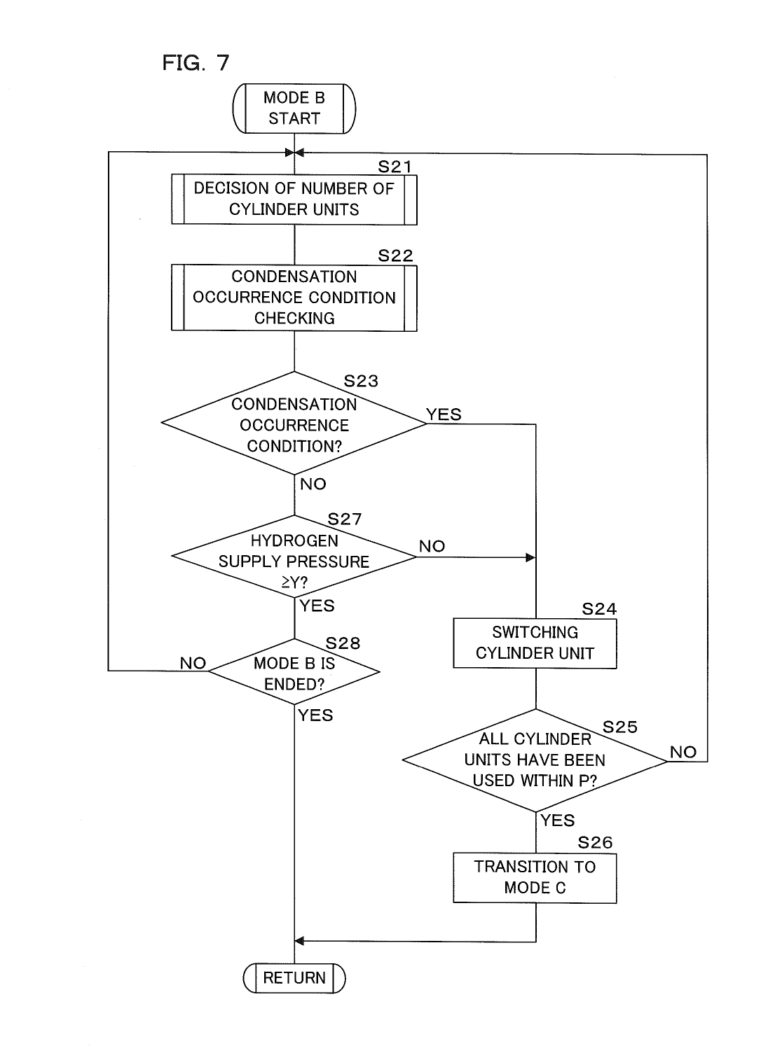

FIG. 7 is a flowchart illustrating the subroutine process according to the mode B.

First, the CPU 91 decides the number of cylinder units in which the on-off valves are to be opened (S21). The CPU 91 performs the subroutine process related to the decision of the number of cylinder units in which the on-off valves are to be opened.

Here, the CPU 91 opens the on-off valve of the cylinder unit having a high priority based on the following Table 2. When the number of the on-off valve that is opened is 1, the cylinder unit having the highest priority is selected, and when the number of the on-off valves that are opened is 2, the two cylinder units having the high priority are selected.

TABLE 2

| PRIORITY | INITIAL STATE |
|---|---|
| UNIT A | 3 |
| UNIT B | 5 |
| UNIT C | 6 |
| UNIT D | 4 |
| UNIT E | 2 |
| UNIT F | 1 |

After the on-off valve is opened, the CPU 91 checks whether or not a condensation occurrence condition on the cylinder unit in which the on-off valve is opened is satisfied (S22). In other words, when the on-off valve of one cylinder unit is opened, the condensation occurrence condition checking process is performed on the cylinder unit, and when the on-off valves of two cylinder units are opened, the condensation occurrence condition checking process is performed on each of the cylinder units.

The CPU 91 performs the subroutine process related to the condensation occurrence condition checking.

The CPU 91 determines whether or not it is determined that the condensation occurrence condition is satisfied by the subroutine process related to the condensation occurrence condition checking (S23).

When the condensation occurrence condition is determined to be satisfied (YES in S23), the CPU 91 switches the cylinder unit (S24).

When the unit F in the initial state is assumed to be currently used, the CPU 91 performs switching to the cylinder unit in which the priority is high and the temperature is equal to or higher than a predetermined value. In other words, when the temperature of the unit E is equal to or higher than a predetermined value, switching from the cylinder unit F in the initial state to the cylinder unit E is performed.

The CPU 91 determines whether or not all cylinder units have been used within the period P of time (S25).

When all cylinder units are determined not to have been used within the period P of time (NO in S25), the CPU 91 causes the process to return to step S21.

When all cylinder units are determined to have been used within the period P of time (YES in S25), the CPU 91 performs transition to the mode C by a compulsory setting (S26), and the subroutine process of the mode B ends.

When the condensation occurrence condition is determined not to be satisfied in step S23 (NO in S23), the CPU 91 determines whether or not the hydrogen supply pressure acquired from the pressure gauge 18 is equal to or higher than Y (kPa) (S27).

When the hydrogen supply pressure is determined not to be equal to or higher than Y (kPa) (NO in S27), the CPU 91 causes the process to proceed to step S24.

When the hydrogen supply pressure is determined to be equal to or higher than Y (kPa) (YES in S27), the CPU 91 determines whether or not the mode B is ended (S28). When the mode B is continued, one cylinder unit can be intensively used. The determination as to whether or not the mode B is ended is performed according to whether or not an instruction to end the mode B has been received from the user, or whether or not a predetermined condition for ending the mode B is determined to have been satisfied by the CPU 91.

When the mode B is determined not to be ended (NO in S28), the CPU 91 causes the process to return to step S21. When the mode B is determined to be ended (YES in S28), the CPU 91 ends the subroutine process.

The subroutine process according to the mode C will be described below.

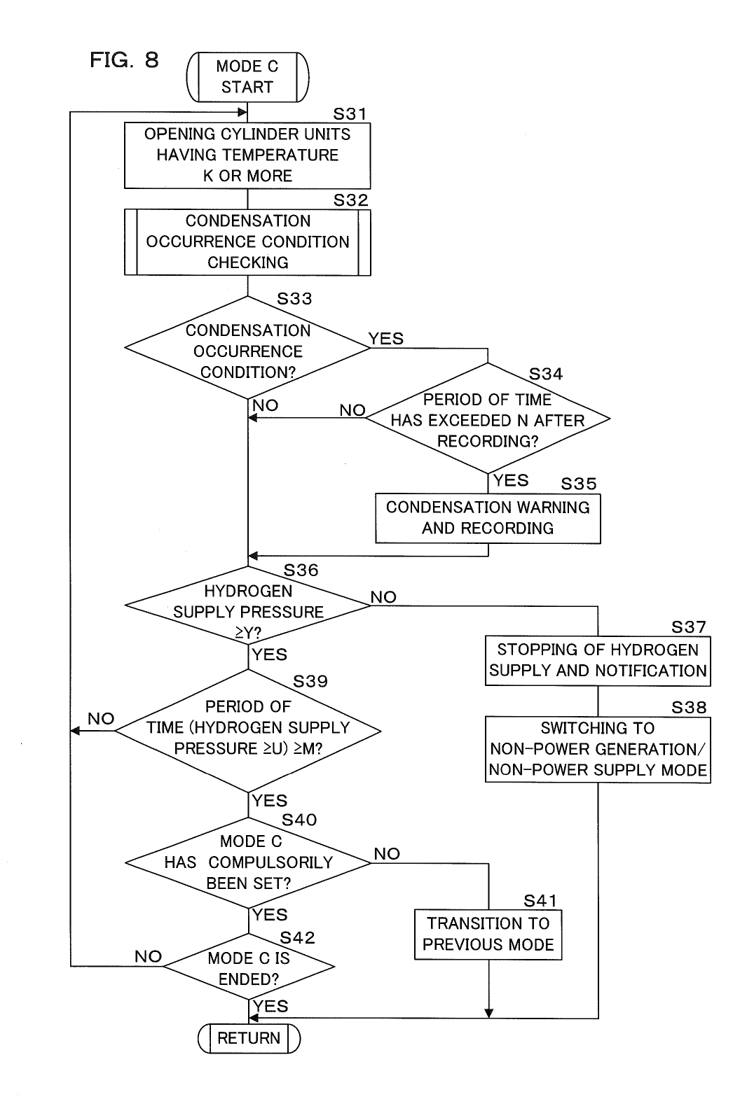

FIG. 8 is a flowchart illustrating the subroutine process according to the mode C.

The CPU 91 opens the on-off valves of all the cylinder units in which the temperature acquired from the temperature sensor is equal to or higher than K° C. (S31).

The CPU 91 performs the subroutine process related to the condensation occurrence condition checking on all the cylinder units being in use (S32).

The CPU 91 determines whether or not all the cylinder units being in use are determined to be in the condensation occurrence condition through the subroutine process related to the condensation occurrence condition checking (S33).

When all the cylinder units being in use are determined to be in the condensation occurrence condition (YES in S33), the CPU 91 determines whether or not a period of time measured by the time measuring unit 93 after recording previous condensation information in the storage unit 94 has exceeded N (S34).

When the period N of time is determined not to have elapsed (NO in S34), the CPU 91 causes the process to proceed to step S36.

When the period N of time is determined to have elapsed (S34:YES), the CPU 91 gives a condensation warning through the notifying unit 15, records condensation information in the storage unit 94 (S35), and causes the process to proceed to step S36. The occurrence of condensation is prevented by opening the on-off valves of all the cylinder units in which the temperature is equal to or higher than K° C., but since the period N of time in which the condensation occurrence condition is satisfied has elapsed in all the cylinder units being in use, it is difficult to prevent condensation through control. Here, a priority is given to continuation of power generation, only recording is performed, and the process proceeds to step S36, and when the hydrogen supply pressure is less than Y (kPa), the hydrogen supply is stopped.

When condensation occurrence condition is determined not to be satisfied in step S33 (NO in S33), the CPU 91 determines whether or not the hydrogen supply pressure acquired from the pressure gauge 18 is equal to or higher than Y (kPa) (S36).

When the hydrogen supply pressure is determined not to be equal to or higher than Y (kPa) (NO in S36), the CPU 91 stops the hydrogen supply, and gives a notification indicating that the hydrogen supply has been stopped through the notifying unit 15 (S37). Then, the CPU 91 switches the stack 8 side to the non-power generation/non-power supply mode (S38), and ends the subroutine process of the mode C.

When the hydrogen supply pressure is determined to be equal to or higher than Y (kPa) (YES in S36), the CPU 91 determines whether or not a period of time in which the hydrogen supply pressure is U (kPa) or more has been continuing for M or more (S39). Here, U>Y is assumed. A condition (the hydrogen supply pressure U and the period M of time) in which the mode C can end under the condensation non-occurrence condition is obtained through an experiment in advance and stored in the storage unit 94.

When the period of time in which the hydrogen supply pressure is U (kPa) or more is determined not to have been continuing for M or more (NO in S39), the CPU 91 causes the process to return to step S31. As the process returns to step S31, it is possible to close the on-off valve of the cylinder unit in which the temperature is currently lower than K° C. and open the on-off valve of the cylinder unit in which the temperature is currently higher than K° C., in contrast.

When the period of time in which the hydrogen supply pressure is U (kPa) or more is determined to have been continuing for M or more (YES in S39), the CPU 91 determines whether or not the mode C has compulsorily been set by the CPU 91 (S40). When the mode C is determined not to have compulsorily been set by the CPU 91 (NO in S40), the CPU 91 performs transition to a mode before the mode C is set (S41), and then ends the subroutine process of the mode C.

When the mode C is determined to have compulsorily been set by the CPU 91 (YES in S40), the CPU 91 determines whether or not the mode C is ended (S42). The determination as to whether or not the mode C is ended is performed according to whether or not an instruction to end the mode C has been received from the user, or whether or not a predetermined condition for ending the mode C is determined to have been satisfied by the CPU 91.

When the mode C is determined not to be ended (NO in S42), the CPU 91 causes the process to return to step S31. When the mode C is determined to be ended (YES in S42), the CPU 91 ends the subroutine process.

A residual hydrogen amount adjustment process among cylinder units when the hydrogen supply is stopped or when the hydrogen supply is in the stop state will be described below.

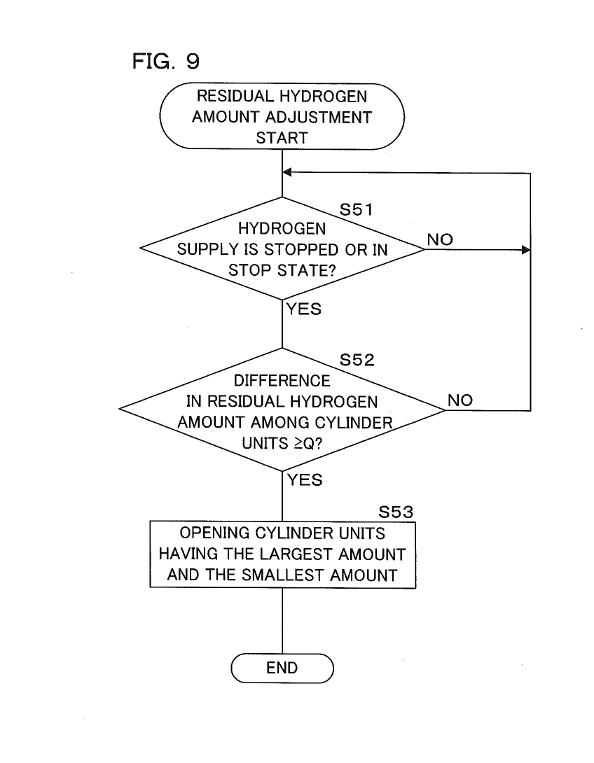

FIG. 9 is a flowchart illustrating the residual hydrogen amount adjustment process between the cylinder units by the CPU 91.

The CPU 91 determines whether or not the hydrogen supply is stopped from now on or is currently in the stop state (S51).

When the hydrogen supply is determined to neither be stopped from now on nor be currently in the stop state (NO in S51), the CPU 91 repeats the determination process.

When the hydrogen supply is determined to be stopped from now on or be currently in the stop state (YES in S51), the CPU 91 determines whether or not a difference in a residual hydrogen amount among the cylinder units is equal to or larger than Q (S52). As an example of Q, there is a case in which a difference in a residual hydrogen amount among cylinder units is 10% when a case in which a cylinder unit is fully filled with hydrogen is 100%. When the difference in the residual hydrogen amount among the cylinder units is determined to be smaller than Q (NO in S52), the CPU 91 causes the process to return to step S51.

When the difference in the residual hydrogen amount among the cylinder units is determined to be equal to or larger than Q (YES in S52), the CPU 91 opens the on-off valves of the cylinder unit having the largest residual hydrogen amount and the cylinder unit having the smallest residual hydrogen amount (S53), and then ends the process. As a result, a state in which hydrogen in the cylinder unit under the condition (heating is difficult and condensation is likely to occur) is likely to remain to the end is easily prevented. Further, since the hydrogen amount difference among the cylinder units is reduced, when the cylinder unit is filled with hydrogen, the cylinder unit can be fully filled in a short time.

Since the fuel cell of the present embodiment is configured as described above, when the power generation amount or the cumulative value of the power generation amount increases, consumption of hydrogen increases, that is, the hydrogen emission amount of the cylinder unit being in use increases, and thus condensation is likely to occur on the cylinder unit, it is possible to suppress the occurrence of condensation by switching the cylinder unit. Thus, the occurrence of a problem such as a short circuit of an electric wiring which is caused by rust or degradation of a component is suppressed.

Further, when the power generation amount is equal to or larger than a predetermined value, hydrogen consumption is high, and a single cylinder unit is used, if a decrease in the surface temperature of the cylinder unit increases and a possibility that condensation will occur is high, it is possible to suppress the occurrence of condensation by using a plurality of cylinder units.

Further, it is possible to suppress the occurrence of condensation satisfactorily by changing the number of cylinder units being used according to the power generation amount.

When the power generation amount is equal to or larger than a predetermined value, but the ambient temperature of the cylinder unit is equal to or higher than a predetermined value, and a possibility that condensation will occur is low, it is possible to supply hydrogen from a single cylinder unit and use the cylinder unit up.

In the present embodiment, when the ambient temperature of the cylinder unit is not F° C. or more, the ambient humidity is not G % or less, and a possibility that condensation will occur is high, transition to the C mode is performed, and hydrogen is supplied from a plurality of cylinder units to the stack 8 at the same time, and thus it is possible to suppress the occurrence of condensation satisfactorily. Then, when the ambient temperature is F° C. or more, or the ambient humidity is G % or less, and no condensation occurs although transition to the mode C is not performed, transition to a necessary mode can be performed. After the transition, the condensation condition checking process is performed, and when a condition in which condensation occurs is determined to be satisfied, it is possible to suppress the occurrence of condensation by switching the cylinder unit. The mode transition can be set to be performed by the user's selection, and in this case, it is possible to satisfy the user's desire, for example, of using the cylinder units up one by one.

As described above, a battery according to an aspect of the present invention comprises: a plurality of hydrogen storage containers each of which stores hydrogen and supplies hydrogen from an inflow/outflow port including an on-off valve; a power generating unit which is supplied with hydrogen from the hydrogen storage container and generates power; and a control unit which controls switching the on-off valve of the hydrogen storage container which supplies hydrogen, wherein the control unit is configured to switch the on-off valve of the hydrogen storage container which supplies hydrogen according to a power generation amount of the power generating unit or a cumulative value of the power generation amount.

In this aspect, when the hydrogen consumption is high, that is, the hydrogen emission amount of the hydrogen storage container being in use is large, the surface temperature of the hydrogen storage container decreases, and thus condensation is likely to occur, it is possible to suppress the occurrence of condensation by switching the on-off valve of the hydrogen storage container which supplies hydrogen. Thus, a problem such as a short circuit of an electric wiring which is caused by rust or degradation of a component is suppressed.

According to an aspect of the present invention, in the battery according to the above aspect, the control unit is configured to supply hydrogen from a plurality of hydrogen storage containers when the power generation amount is equal to or larger than a first threshold value.

In this aspect, when the power generation amount is equal to or larger than a first threshold value, hydrogen consumption is high, and a single hydrogen storage container unit is used, if a decrease in the surface temperature of the hydrogen storage container increases, and a possibility that condensation will occur is high, it is possible to suppress the occurrence of condensation by using a plurality of cylinder units.

According to an aspect of the present invention, in the battery according to the above aspect, the control unit changes the number of hydrogen storage containers which supply hydrogen according to the power generation amount.

In this aspect, it is possible to suppress the occurrence of condensation satisfactorily by changing the number of hydrogen storage containers which supply hydrogen according to the power generation amount.

According to an aspect of the present invention, in the battery according to the above aspect, the control unit is configured to open one on-off valve when the power generation amount is equal to or larger than a first threshold value and equal to or smaller than a second threshold value, and an ambient temperature is equal to or higher than a predetermined value.

In this aspect, when the power generation amount is equal to or larger than a first threshold value and equal to or smaller than a second threshold value, but the ambient temperature of the hydrogen storage container is equal to or higher than a predetermined value, and a possibility that condensation will occur is low, it is possible to supply hydrogen from a single hydrogen storage container.

According to an aspect of the present invention, in the battery according to the above aspect, a threshold value of the cumulative value is decided based on the ambient temperature of the hydrogen storage container which supplies hydrogen and a hydrogen use amount per hour.

In this aspect, when the ambient temperature of the hydrogen storage container is low, and the hydrogen use amount per hour is large, a possibility that condensation will occur is high, but switching is promoted by decreasing the threshold value used for determining switching of the on-off valve of the hydrogen storage container which supplies hydrogen, and thus it is possible to suppress the occurrence of condensation. Then, when the ambient temperature of the hydrogen storage container is high, and the hydrogen use amount per hour is small, a possibility that condensation will occur is low, and thus the same hydrogen storage container can be continuously used by increasing the threshold value.

A battery according to an aspect of the present invention comprises: a plurality of hydrogen storage containers each of which stores hydrogen and supplies hydrogen from an inflow/outflow port including an on-off valve; a power generating unit which is supplied with hydrogen from the hydrogen storage container and generates power; and a control unit which controls switching the on-off valve of the hydrogen storage container which supplies hydrogen, wherein the control unit is configured to switch the on-off valve of the hydrogen storage container which supplies hydrogen based on an ambient temperature of the hydrogen storage container or ambient humidity of the hydrogen storage container.

In this aspect, when condensation is considered to occur based on the ambient temperature or humidity of the hydrogen storage container, the occurrence of condensation can be prevented by switching the on-off valve of the hydrogen storage container which supplies hydrogen. Thus, a problem such as a short circuit of an electric wiring caused by rust or degradation of a component is suppressed.

According to an aspect of the present invention, the battery according to the above aspect has a plurality of modes for switching the hydrogen storage container which supplies hydrogen, and the control unit is configured to switch the mode.

In this aspect, an appropriate mode can be selected according to the use state such as a surrounding environment (temperature and humidity) of the hydrogen storage container, the hydrogen supply amount, or the power generation amount, and the user's desire, for example, of using the hydrogen storage container one by one.

According to an aspect of the present invention, the battery according to the above aspect further comprises a unit which accepts switching of the mode.

In this aspect, the mode can be selected according to the user's desire.

According to an aspect of the present invention, in the battery according to the above aspect, the control unit determines whether or not the ambient temperature of the hydrogen storage container is equal to or higher than a predetermined value or the ambient humidity of the hydrogen storage container is equal to or lower than a predetermined value, when the ambient temperature of the hydrogen storage container is determined not to be equal to or higher than the predetermined value and the ambient humidity of the hydrogen storage container is determined not to be equal to or lower than the predetermined value, the control unit performs transition to a first mode in which hydrogen is supplied to the power generating unit simultaneously through a plurality of hydrogen storage containers, and when the ambient temperature of the hydrogen storage container is determined to be equal to or higher than the predetermined value or the ambient humidity of the hydrogen storage container is determined to be equal to or lower than the predetermined value, the control unit performs transition to a second mode in which the hydrogen storage container is used one by one or a third mode in which the hydrogen storage container is used on average.

In this aspect, when the ambient temperature of the hydrogen storage container is not equal to or higher than a predetermined value, the ambient humidity is not equal to or lower than a predetermined value, and a single hydrogen storage container is used, if emission of hydrogen is concentrated, and a possibility that condensation will occur is high, hydrogen is supplied from a plurality of hydrogen storage containers to the power generating unit at the same time, and thus it is possible to suppress the occurrence of condensation satisfactorily. Then, when the ambient temperature is equal to or higher than a predetermined value, or the ambient humidity is equal to or lower than a predetermined value, and no condensation occurs although a plurality of hydrogen storage containers are not used at the same time, transition to a necessary mode can be performed.

According to an aspect of the present invention, in the battery according to the above aspect, after transition to any one mode is performed, the control unit determines whether or not a condition in which condensation occurs on the hydrogen storage container is satisfied, and when the condition in which condensation occurs is determined to be satisfied, the control unit switches the hydrogen storage container which supplies hydrogen.

In this aspect, when a condition in which condensation occurs is satisfied after transition to any one mode is performed, it is possible to suppress the occurrence of condensation by switching the hydrogen storage container.

According to an aspect of the present invention, in the battery according to the above aspect, the hydrogen storage container is heated by air including heat generated by the power generating unit, and the control unit is configured to calculate a condensation temperature based on the temperature and humidity of the air, calculate a decrease in the temperature of the air based on the temperature of the air and the ambient temperature of the hydrogen storage container which supplies hydrogen, and determine whether or not condensation occurs on the hydrogen storage container based on the temperature of the air and the decrease in the temperature.

In this aspect, it is possible to accurately determine whether or not condensation occurs.

According to an aspect of the present invention, in the battery according to the above aspect, the control unit is configured to supply hydrogen from a plurality of hydrogen storage containers when the on-off valves of all the hydrogen storage containers are switched within a predetermined period of time.

In this aspect, when all hydrogen storage containers are in a state close to a condition in which condensation occurs, it is possible to suppress the occurrence of condensation satisfactorily using a plurality of hydrogen storage containers.

According to an aspect of the present invention, in the battery according to the above aspect, in the case where a difference in a residual hydrogen amount among the hydrogen storage containers is equal to or larger than a predetermined value when the hydrogen supply is stopped or in a stop state, the on-off valve of the hydrogen storage container having the largest residual hydrogen amount and the on-off valve of the hydrogen storage container having the smallest residual hydrogen amount are opened.

In this aspect, it is possible to fill the hydrogen storage container with hydrogen perfectly in a short time when it is refilled with hydrogen.

A method of switching a hydrogen storage container in a battery including a plurality of hydrogen storage containers each of which stores hydrogen and supplies hydrogen to a power generating unit, according to an aspect of the present invention, comprises: determining whether or not an ambient temperature of the hydrogen storage container is equal to or higher than a predetermined value or ambient humidity of the hydrogen storage container is equal to or lower than a predetermined value; performing transition to a first mode in which hydrogen is supplied to the power generating unit simultaneously through a plurality of hydrogen storage containers when the ambient temperature of the hydrogen storage container is determined not to be equal to or higher than the predetermined value and the ambient humidity of the hydrogen storage container is determined not to be equal to or lower than the predetermined value; performing transition to a second mode in which the hydrogen storage container is used one by one or a third mode in which the hydrogen storage container is used on average when the ambient temperature of the hydrogen storage container is determined to be equal to or higher than the predetermined value or the ambient humidity of the hydrogen storage container is determined to be equal to or lower than the predetermined value; determining whether or not a condition in which condensation occurs on the hydrogen storage container is satisfied; and switching the hydrogen storage container which supplies hydrogen when the condition in which condensation occurs is determined to be satisfied.

In this aspect, when the ambient temperature of the hydrogen storage container is not equal to or higher than a predetermined value, the ambient humidity is not equal to or lower than a predetermined value, and a single hydrogen storage container is used, if emission of hydrogen is concentrated and a possibility that condensation will occur is high, it is possible to suppress the occurrence of condensation satisfactorily by supplying hydrogen from a plurality of hydrogen storage containers to the power generating unit at the same time. Then, when the ambient temperature is equal to or higher than a predetermined value, or the ambient humidity is equal to or lower than a predetermined value, and no condensation occurs although a plurality of hydrogen storage containers are not used at the same time, transition to a necessary mode can be performed. Then, when a condition in which condensation occurs is satisfied after the transition is performed, it is possible to suppress the occurrence of condensation by switching the hydrogen storage container.

A computer readable recording medium according to an aspect of the present invention, recording a computer program causing a computer which controls switching a hydrogen storage container in a battery including a plurality of hydrogen storage containers each of which stores hydrogen and supplies hydrogen to a power generating unit to execute a process of: determining whether or not an ambient temperature of the hydrogen storage container is equal to or higher than a predetermined value or ambient humidity of the hydrogen storage container is equal to or lower than a predetermined value; performing transition to a first mode in which hydrogen is supplied to the power generating unit simultaneously through a plurality of hydrogen storage containers when the ambient temperature of the hydrogen storage container is determined not to be equal to or higher than the predetermined value and the ambient humidity of the hydrogen storage container is determined not to be equal to or lower than the predetermined value; performing transition to a second mode in which the hydrogen storage container is used one by one or a third mode in which the hydrogen storage container is used on average when the ambient temperature of the hydrogen storage container is determined to be equal to or higher than the predetermined value or the ambient humidity of the hydrogen storage container is determined to be equal to or lower than the predetermined value; determining whether or not a condition in which condensation occurs on the hydrogen storage container is satisfied; and outputting a command for switching the hydrogen storage container which supplies hydrogen when the condition in which condensation occurs is determined to be satisfied.

In this aspect, when the ambient temperature of the hydrogen storage container is not equal to or higher than a predetermined value, the ambient humidity is not equal to or lower than a predetermined value, and a possibility that condensation will occur is high, it is possible to suppress the occurrence of condensation satisfactorily by supplying hydrogen from a plurality of hydrogen storage containers to the power generating unit at the same time. Then, when the ambient temperature is equal to or higher than a predetermined value, or the ambient humidity is equal to or lower than a predetermined value, and no condensation occurs although a plurality of hydrogen storage containers are not used at the same time, transition to a necessary mode can be performed. Then, when a condition in which condensation occurs is satisfied after the transition is performed, it is possible to suppress the occurrence of condensation by switching the hydrogen storage container.

The present invention is not limited to content of the above embodiment, and various changes can be made in claims set forth below. In other words, an embodiment obtained by combining technical means appropriately changed in claims set forth below is also included in a technical scope of the present invention.

For example, the configuration of each unit of the fuel cell 100 such as the hydrogen storage unit 10, the number of cylinder units, content of the mode, and the like are not limited to the example described in the above embodiment. Further, the present invention is not limited to the example in which the cylinder unit is heated by air including heat generated by the stack 8.

Moreover, the fuel cell to which the present invention is applied is not limited to the polymer electrolyte fuel cell. In addition, the battery is not limited to the fuel cell, and the present invention can be applied even to any other hydrogen battery which supplies a power generating unit with hydrogen.

And it is noted that, as used herein and in the appended claims, the singular forms “a”, “an”, and “the” include plural referents unless the context clearly dictates otherwise.

What is claimed is:

1. A battery, comprising:
a plurality of hydrogen storage containers each of which stores hydrogen and supplies hydrogen from an inflow/outflow port including an on-off valve;
a power generating unit which is supplied with hydrogen from the hydrogen storage container and generates power; and
a control unit which controls switching the on-off valve of the hydrogen storage container which supplies hydrogen,
wherein the control unit is configured to switch the on-off valve of the hydrogen storage container which supplies hydrogen according to a power generation amount of the power generating unit or a cumulative value of the power generation amount.

2. The battery according to claim 1,
wherein the control unit is configured to supply hydrogen from a plurality of hydrogen storage containers when the power generation amount is equal to or larger than a first threshold value.

3. The battery according to claim 2,
wherein the control unit changes the number of hydrogen storage containers which supply hydrogen according to the power generation amount.

4. The battery according to claim 1,
wherein the control unit is configured to open one on-off valve when the power generation amount is equal to or larger than a first threshold value and equal to or smaller than a second threshold value, and an ambient temperature is equal to or higher than a predetermined value.

5. The battery according to claim 1,
wherein a threshold value of the cumulative value is decided based on the ambient temperature of the hydrogen storage container which supplies hydrogen and a hydrogen use amount per hour.

6. A battery, comprising:
a plurality of hydrogen storage containers each of which stores hydrogen and supplies hydrogen from an inflow/outflow port including an on-off valve;
a power generating unit which is supplied with hydrogen from the hydrogen storage container and generates power; and
a control unit which controls switching the on-off valve of the hydrogen storage container which supplies hydrogen,
wherein the control unit is configured to switch the on-off valve of the hydrogen storage container which supplies hydrogen based on an ambient temperature of the hydrogen storage container or ambient humidity of the hydrogen storage container.

7. The battery according to claim 6,
wherein the battery has a plurality of modes for switching the hydrogen storage container which supplies hydrogen, and
the control unit is configured to switch the mode.

8. The battery according to claim 7, further comprising,
a unit which accepts switching of the mode.

9. The battery according to claim 7,
wherein the control unit determines whether or not the ambient temperature of the hydrogen storage container is equal to or higher than a predetermined value or the ambient humidity of the hydrogen storage container is equal to or lower than a predetermined value,
when the ambient temperature of the hydrogen storage container is determined not to be equal to or higher than the predetermined value and the ambient humidity of the hydrogen storage container is determined not to be equal to or lower than the predetermined value, the control unit performs transition to a first mode in which hydrogen is supplied to the power generating unit simultaneously through a plurality of hydrogen storage containers, and
when the ambient temperature of the hydrogen storage container is determined to be equal to or higher than the predetermined value or the ambient humidity of the hydrogen storage container is determined to be equal to or lower than the predetermined value, the control unit performs transition to a second mode in which the hydrogen storage container is used one by one or a third mode in which the hydrogen storage container is used on average.

10. The battery according to claim 8,
wherein the control unit determines whether or not the ambient temperature of the hydrogen storage container is equal to or higher than a predetermined value or the ambient humidity of the hydrogen storage container is equal to or lower than a predetermined value,
when the ambient temperature of the hydrogen storage container is determined not to be equal to or higher than the predetermined value and the ambient humidity of the hydrogen storage container is determined not to be equal to or lower than the predetermined value, the control unit performs transition to a first mode in which hydrogen is supplied to the power generating unit simultaneously through a plurality of hydrogen storage containers, and
when the ambient temperature of the hydrogen storage container is determined to be equal to or higher than the predetermined value or the ambient humidity of the hydrogen storage container is determined to be equal to or lower than the predetermined value, the control unit performs transition to a second mode in which the hydrogen storage container is used one by one or a third mode in which the hydrogen storage container is used on average.

11. The battery according to claim 9,
wherein after transition to any one mode is performed,
the control unit determines whether or not a condition in which condensation occurs on the hydrogen storage container is satisfied, and
when the condition in which condensation occurs is determined to be satisfied, the control unit switches the hydrogen storage container which supplies hydrogen.

12. The battery according to claim 10,
wherein after transition to any one mode is performed,
the control unit determines whether or not a condition in which condensation occurs on the hydrogen storage container is satisfied, and
when the condition in which condensation occurs is determined to be satisfied, the control unit switches the hydrogen storage container which supplies hydrogen.

13. The battery according to claim 11,
wherein the hydrogen storage container is heated by air including heat generated by the power generating unit, and
the control unit is configured to calculate a condensation temperature based on the temperature and humidity of the air, calculate a decrease in the temperature of the air based on the temperature of the air and the ambient temperature of the hydrogen storage container which supplies hydrogen, and determine whether or not condensation occurs on the hydrogen storage container based on the temperature of the air and the decrease in the temperature.

14. The battery according to claim 12,
wherein the hydrogen storage container is heated by air including heat generated by the power generating unit, and
the control unit is configured to calculate a condensation temperature based on the temperature and humidity of the air, calculate a decrease in the temperature of the air based on the temperature of the air and the ambient temperature of the hydrogen storage container which supplies hydrogen, and determine whether or not condensation occurs on the hydrogen storage container based on the temperature of the air and the decrease in the temperature.

15. The battery according to claim 1,
wherein the control unit is configured to supply hydrogen from a plurality of hydrogen storage containers when the on-off valves of all the hydrogen storage containers are switched within a predetermined period of time.

16. The battery according to claim 6,
wherein the control unit is configured to supply hydrogen from a plurality of hydrogen storage containers when the on-off valves of all the hydrogen storage containers are switched within a predetermined period of time.

17. The battery according to claim 1,
wherein in the case where a difference in a residual hydrogen amount among the hydrogen storage containers is equal to or larger than a predetermined value when the hydrogen supply is stopped or in a stop state, the on-off valve of the hydrogen storage container having the largest residual hydrogen amount and the on-off valve of the hydrogen storage container having the smallest residual hydrogen amount are opened.

18. The battery according to claim 6,
wherein in the case where a difference in a residual hydrogen amount among the hydrogen storage containers is equal to or larger than a predetermined value when the hydrogen supply is stopped or in a stop state, the on-off valve of the hydrogen storage container having the largest residual hydrogen amount and the on-off valve of the hydrogen storage container having the smallest residual hydrogen amount are opened.

19. A method of switching a hydrogen storage container in a battery including a plurality of hydrogen storage containers each of which stores hydrogen and supplies hydrogen to a power generating unit, the method comprising:
determining whether or not an ambient temperature of the hydrogen storage container is equal to or higher than a predetermined value or ambient humidity of the hydrogen storage container is equal to or lower than a predetermined value;
performing transition to a first mode in which hydrogen is supplied to the power generating unit simultaneously through a plurality of hydrogen storage containers when the ambient temperature of the hydrogen storage container is determined not to be equal to or higher than the predetermined value and the ambient humidity of the hydrogen storage container is determined not to be equal to or lower than the predetermined value;
performing transition to a second mode in which the hydrogen storage container is used one by one or a third mode in which the hydrogen storage container is used on average when the ambient temperature of the hydrogen storage container is determined to be equal to or higher than the predetermined value or the ambient humidity of the hydrogen storage container is determined to be equal to or lower than the predetermined value;
determining whether or not a condition in which condensation occurs on the hydrogen storage container is satisfied; and
switching the hydrogen storage container which supplies hydrogen when the condition in which condensation occurs is determined to be satisfied.

20. A computer readable recording medium recording a computer program causing a computer which controls switching a hydrogen storage container in a battery including a plurality of hydrogen storage containers each of which stores hydrogen and supplies hydrogen to a power generating unit to execute a process of:
determining whether or not an ambient temperature of the hydrogen storage container is equal to or higher than a predetermined value or ambient humidity of the hydrogen storage container is equal to or lower than a predetermined value;
performing transition to a first mode in which hydrogen is supplied to the power generating unit simultaneously through a plurality of hydrogen storage containers when the ambient temperature of the hydrogen storage container is determined not to be equal to or higher than the predetermined value and the ambient humidity of the hydrogen storage container is determined not to be equal to or lower than the predetermined value;
performing transition to a second mode in which the hydrogen storage container is used one by one or a third mode in which the hydrogen storage container is used on average when the ambient temperature of the hydrogen storage container is determined to be equal to or higher than the predetermined value or the ambient humidity of the hydrogen storage container is determined to be equal to or lower than the predetermined value;
determining whether or not a condition in which condensation occurs on the hydrogen storage container is satisfied; and
outputting a command for switching the hydrogen storage container which supplies hydrogen when the condition in which condensation occurs is determined to be satisfied.
